(19) United States
(12) Patent Application Publication
(10) Pub. No.: US 2009/0267911 A1
(43) Pub. Date: Oct. 29, 2009

(54) Touch Screen

(76) Inventors: Yu-Cheng Huang, Hsinchu City (TW); Tzu-Chih Lin, Hsinchu City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/408,804

(22) Filed: Mar. 23, 2009

(30) Foreign Application Priority Data
Apr. 28, 2008 (TW) 097115586

(51) Int. Cl. G06F 3/041

(52) U.S. Cl. 345/173

(57) ABSTRACT

The present invention discloses a touch screen comprising a flexible print circuit board, an electrically conducting layer, and a flexible control board. The flexible print circuit board has a functional plane, and the functional plane comprises a plurality of electrically conducting areas. Each of the electrically conducting areas is capable of transmitting a corresponding signal when conducted. The electrically conducting layer is disposed on the functional plane of the flexible print circuit board. The flexible control board covers on the conducting layer and comprises a plurality of pressing areas, wherein each of the pressing areas corresponds to one of the conducting areas. By pressing any of the pressing areas, the corresponding electrically conducting area on the flexible print circuit board is conducted, so the conducted electrically conducting area transmits the corresponding signal.

### BACKGROUND OF THE INVENTION

1. Field of invention

The present invention relates to a touch screen, and more particularly, to a touch screen which utilizes a flexible print circuit board.

2. Description of related art

The applications of the touch screen are extensively used nowadays, whereas during its early stages, it was mainly used in the military or for certain applications only. Today, the applications of the touch screen can be commonly found in various electronic products, which comprise the capacitor touch screen, resistor touch screen, and infrared touch screen.

The capacitor touch screen coats on a surface of a transparent glass with a layer of oxidizing metal, and four corners of the glass provide voltage, which creates an even electric field on the surface of the glass. When a finger contacts the screen, the changes in the capacitance caused by the static electricity between the finger and the electric field can be used to determine the input coordinates.

The resistor touch screen is created by combining an upper and a lower set of Indium Tin Oxide (ITO) conducting films. Pressure on the screen causes the upper and the lower electrodes to conduct electricity, and a controller is used to detect the voltage change on the screen. The controller then calculates the coordinates of the virtual button that has been pressed and performs the operation accordingly. The outermost layer of the resistor touch screen is a conducting glass.

The infrared touch screen has been installed with an infrared emitter on one side of the X-axis and the Y-axis of the screen, as well as receivers on the opposite side of the screen g. When the screen is pressed, the infrared signals are interfered. The corresponding coordinate of the interference can be calculated, and the device then performs the operation accordingly.

Currently, the Liquid Crystal Display (LCD) is the type most commonly used for screens, but it requires numerous layers of glass in order to provide the internal image display and to protect the surface of the screen. As a result, the brightness of the screen decreases. If the brightness of conventional screens needs to be increased, the voltage has to be raised. In addition, the structures and components of the current touch screens are complicated, which inevitably increases the manufacturing cost. Therefore, it is necessary to provide a touch screen which provides low manufacturing costs and a high transmittance ratio.

### SUMMARY OF THE INVENTION

One objective of the present invention is to provide a touch screen which is low in manufacturing costs. The other objective is to provide a touch screen which has a high transmittance ratio.

Thus, the present invention provides a touch screen which can achieve the objectives mentioned above. The touch screen comprises a flexible print circuit board, a conducting layer, and a flexible control board. The flexible print circuit board has a functional plane comprising a plurality of electrically conducting areas, wherein each of electrically conducting areas is capable of transmitting a corresponding signal when conducted. The conducting layer is on top of the flexible print circuit board. The flexible control board covers on the surface of the conducting layer and comprises a plurality of pressing areas corresponding to the electrically conducting area respectively. When any pressing area on the flexible print circuit board is pressed, the conducting layer provides electronically conduction for one of the conduct areas corresponding to the pressed pressing area, so as to make the electrically conducting area transmitting the corresponding signal.

One of the embodiments of the present invention is a touch screen comprising an insulation layer, wherein the insulation layer is disposed between the flexible print circuit board and the conducting layer. The insulation layer comprises a plurality of openings, wherein each of the openings is corresponding to each of the electrically conducting areas.

In another embodiment of the present invention, the flexible print circuit board comprises a silver paste PCB, the conducting layer comprises a copper coated film, the flexible control board comprises an organic light emitting diode (OLED) screen, and the insulation layer comprises a Mylar film.

Hence, the structure of the present invention is simple. The silver paste PCB, the copper coated film, and the Mylar film are all low-cost materials, which can achieve the objective of reducing manufacturing costs. The organic light emitting diodes used on the screen are a flexible component such that the user can press directly on the OLED screen to conduct the silver paste PCB, which then performs the necessary operation. Comparing to the prior arts, the present invention does not need additional glasses to aid the detection of the pressing on the screen. As a result, the OLED screen can emit light directly to the outside, so as to achieve the objective of increasing the transmittance ratio.

### DETAILED DESCRIPTION OF THE PREFERRED EMBODIMENT

The advantages and innovative features of the present invention will become more apparent from the following preferred embodiments.

Refer to FIG. 1 and FIG. 2 of the touch screen in accordance with the present invention. The touch screen of the present invention can be applied to an electronic device, wherein the function of the touch screen can replace the original functions provided by keystrokes or the like of the electronic device.

FIG. 1 is an exploded perspective view of a touch screen for the first embodiment of the present invention. The touch screen 1 of the present invention comprises a flexible print circuit board 10, a conducting layer 20, and a flexible control board 30, wherein the flexible print circuit board 10 comprises a functional plane 11. The functional plane 11 is configured with a plurality of electrically conducting areas 12 thereon. Each of the electrically conducting areas 12 transmits a corresponding signal when conducted. The conducting layer 20 is disposed on the functional plane 11 of the flexible circuit board 10. Furthermore, the flexible control board 30 covers on the conducting layer 20. The flexible control board 30 comprises a plurality of pressing areas 31, wherein each of pressing areas 31 corresponds to each of the electrically conducting areas 12 respectively.

In one of the embodiments of the present invention, the flexible print circuit board 10 may be a silver paste PCB. The conducting layer 20 may be a copper coated film. The flexible control board 30 may be an organic light emitting diode (OLED) screen. However, the present invention is not limited to the abovementioned materials. For example, in another of the embodiments of the present invention, the flexible print circuit board 10 may be an Indium Tin Oxide conducting film, which can also achieve the same objective.

In a preferred embodiment, the flexible control board 30 is an organic light emitting diode (OLED). Thus, the touch screen 1 has the characteristic of being flexible and self-luminescent. In comparison to other screens, in this embodiment, the touch screen 1 is more brightly, has a greater angle of view, and consumes less power energy. Furthermore, a user can press directly on the OLED touch screen, which conducts the silver paste PCB and performs the necessary operation. Comparing to the prior arts, the present invention does not need additional glasses to aid in the detection of the pressing on the screen. As a result, the OLED touch screen can emit light directly to the outside without the additional glass, so as to achieve the objective of increasing the transmittance ratio.

As shown in FIG. 1, the plurality of pressing areas 31 can be used as quick access buttons of an electrical device (not shown). When the user presses on any pressing area 31 of the flexible control board 30, the pressure causes the conducting layer 20 to be in contact with one of the electrically conducting areas 12 corresponding to the pressed pressing area 31. The conducted electrically conducting area 12, thus, is provided with electrical conduction for transmitting a corresponding signal and activating the corresponding function of the electrical device.

FIG. 2 is a top view of an electrically conducting area of a touch screen. The electrically conducting area 12 comprises an external electrically conducting area 121 and an internal electrically conducting area 122. When the conducting layer 20 is pressed, the external electrically conducting area 121 and the internal electrically conducting area 122 can be electronically conducted with the conducting layer 20 respectively, so the external electrically conducting area 121 and the internal electrically conducting area 122 can be electrically connected with each other. Therefore, the electrically conducting areas 12 are enabled to transmit signals to the electronic device (not shown) and activate the corresponding function. It should be understood that the form or the shape of the electrically conducting area 12 is not limited to FIG. 2, which can be varied according to the design requirement.

Refer to FIG. 3 for the second embodiment of the present invention, which shows an exploded perspective view of a touch screen. As shown in FIG. 3, the main difference between the present embodiment and the embodiment mentioned above is that the touch screen 1 further comprises an insulation layer 40. The insulation layer 40 is disposed between the flexible print circuit board 10 and the conducting layer 20. The insulation layer 40 comprises a plurality of openings 41, wherein each of the openings 41 corresponds to one electrically conducting area 12 respectively. When there are a large number of the pressing areas 31 (i.e. numerous buttons for the user to press on the touch screen), an insulation layer 40 is introduced to avoid erroneous detections resulting from the electrically conducting areas 12 disposed too closely with each other. When the user presses, the flexible print circuit board 10 is pressed; the openings 41 on the insulation layer 40 prevent the electrically conducting areas 12 from being conducted incorrectly. The conducting layer 20 can correctly conduct with the electrically conducting area 12 corresponding to the pressed pressing area 31.

In one of the embodiments of the present invention, the insulation layer 40 is a Mylar film. It should be understood that the present invention is not limited to this material, for any insulation film that is flexible can be used to achieve the objective of the present invention.

Although the present invention has been explained in relation to its preferred embodiment, it is also of vital importance to acknowledge that many other possible modifications and variations can be made without departing from the spirit and scope of the invention as hereinafter claimed.

### BRIEF DESCRIPTION OF THE DRAWINGS

FIG. 1 is an exploded perspective view of the first embodiment of the present invention.

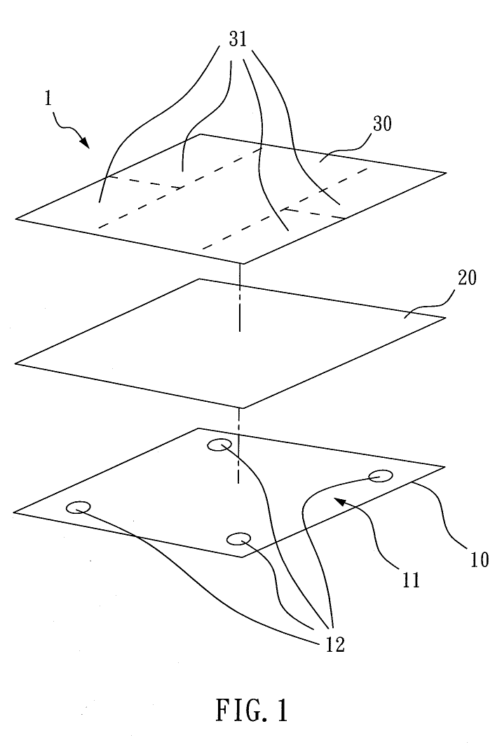

FIG. 2 is a top view of the electrically conducting area s of the touch screen.

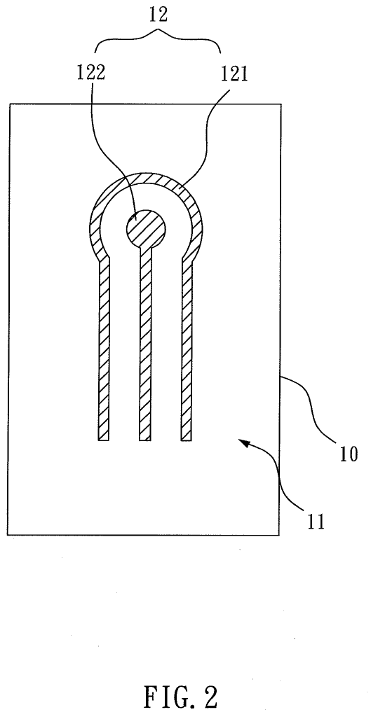

FIG. 3 is an exploded perspective view of the second embodiment of the present invention.

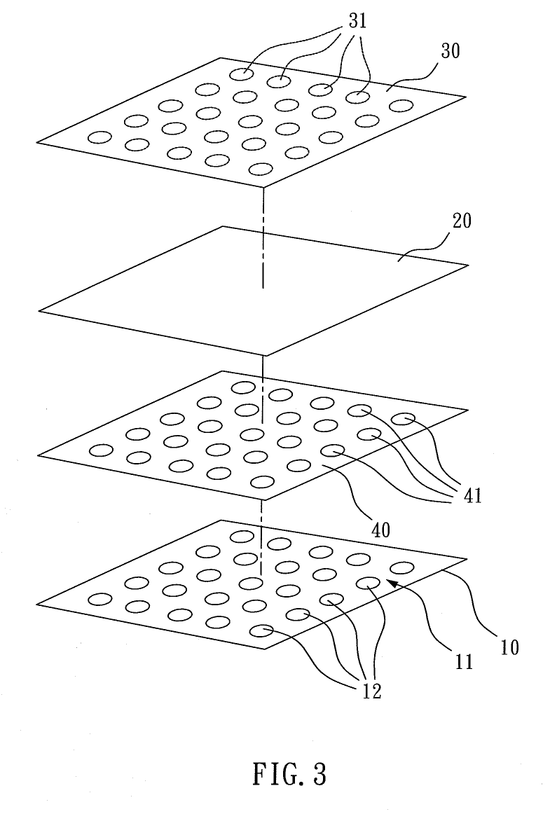

What is claimed is:

1. A touch screen comprising:
a flexible print circuit board (PCB) comprising a functional plane and a plurality of electrically conducting areas on the functional plane;
a conducting layer disposed on the functional plane of the flexible print circuit board, wherein each of the electrically conducting areas is capable of transmitting a corresponding signal when conducted by the conducting layer; and
a flexible control board covering on the conducting layer and comprising a plurality of pressing areas, wherein each of the pressing areas corresponds to one of the plurality of electrically conducting areas respectively;
when any of the pressing areas is pressed, the conducting layer is contacted with one of the corresponding electrically conducting areas on the flexible print circuit board for providing electrically conduction, and the one conducted electrically conducting area transmits the corresponding signal.

2. The touch screen as claimed in claim 1 further comprising an insulation layer disposed in between the flexible print circuit board and the electrically conducting layer.

3. The touch screen as claimed in claim 2, wherein the insulation layer comprises a plurality of openings, and each of the openings corresponds to each of the electrically conducting areas of the flexible control board.

4. The touch screen as claimed in claim 1, wherein the flexible print circuit board comprises a silver paste PCB.

5. The touch screen as claimed in claim 1, wherein the conducting layer comprises a copper coated film.

6. The touch screen as claimed in claim 1, wherein the flexible control board comprises an organic light emitting diode (OLED).

7. The touch screen as claimed in claim 2, wherein the insulation layer comprises a Mylar film.
